(19) United States
(12) Patent Application Publication
(10) Pub. No.: US 2014/0176996 A1
(43) Pub. Date: Jun. 26, 2014

(54) INFORMATION PROCESSING APPARATUS, INFORMATION PROCESSING METHOD, AND COMPUTER PROGRAM PRODUCT

(71) Applicant: Naoyuki IIDA, Tokyo (JP)

(72) Inventor: Naoyuki IIDA, Tokyo (JP)

(21) Appl. No.: 14/134,319

(22) Filed: Dec. 19, 2013

(30) Foreign Application Priority Data
Dec. 25, 2012 (JP) 2012-281632

(51) Int. Cl. G06F 3/12

(52) U.S. Cl. CPC G06F 3/1205
USPC 358/1.15

(57) ABSTRACT

An information processing apparatus includes: a display processing unit configured to display a preview of content of an image file; an acquisition unit configured to acquire designation information which designates an image to be printed in the image file in units of a page; and a creation unit configured to create a print job in which a page designated by the designation information is to be printed.

### CROSS-REFERENCE TO RELATED APPLICATIONS

The present application claims priority to and incorporates by reference the entire contents of Japanese Patent Application No. 2012-281632 filed in Japan on Dec. 25, 2012.

### BACKGROUND OF THE INVENTION

1. Field of the Invention

The present invention relates to an information processing apparatus, an information processing method, and a computer program product.

2. Description of the Related Art

There is a known printing and editing system in which print document data is created from image data by collectively submitting data created by scanning paper originals and/or application data. In the printing and editing system, there is a submission method by which a print job is created by designating files which each contain one or a plurality of original data at the same time. Also, there is a known technique in which a preview of content of a first page of a selected original file is displayed, so that content of the first page can be checked before submitting to the printing and editing system.

For example, Japanese Laid-open Patent Publication No. 2005-309514 discloses a document processing apparatus including an electronic document file creation unit configured to create an electronic document file containing an image page and a non-image page, an editing unit configured to edit the image page in the electronic document file, and a determination unit configured to determine, for each page which forms a group of pages selected from the electronic document as an editing target of the editing unit, whether the page is an image page or a non-image page, wherein a group of pages determined to be the image page by the determination unit is determined as the editing target of the editing unit.

However, there is a problem in that an unnecessary page cannot be effectively excluded beforehand in the case of unifying a plurality of image files in one document.

In view of the above, there is a need to provide an information processing apparatus, an information processing method, and a computer program product which are capable of effectively excluding an unnecessary page beforehand in the case of unifying image files in one document.

### SUMMARY OF THE INVENTION

It is an object of the present invention to at least partially solve the problems in the conventional technology.

An information processing apparatus includes: a display processing unit configured to display a preview of content of an image file; an acquisition unit configured to acquire designation information which designates an image to be printed in the image file in units of a page; and a creation unit configured to create a print job in which a page designated by the designation information is to be printed.

An information processing method includes: displaying a preview of content of an image file; acquiring designation information which designates, in units of a page, an image to be printed in the image file; and creating a print job in which a page designated by the designation information is to be printed.

A computer program product includes a non-transitory computer-usable medium having computer-readable program codes embodied in the medium. The program codes when executed cause a computer to execute: displaying a preview of content of an image file; acquiring designation information which designates, in units of a page, an image to be printed in the image file; and creating a print job in which a page designated by the designation information is to be printed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram illustrating an overview of functions included in an information processing apparatus according to an embodiment;

FIG. 2 is an exemplary view of a new job creating screen which is displayed on a display device by a display processing unit in accordance with manipulated input by a user;

FIG. 3 is a diagram exemplifying a relation between an image file and a print job in the case where specific pages are designated on the new job creating screen;

FIG. 4 is a diagram exemplifying a relation between an image file and a print job in the case where continuous pages are designated on the new job creating screen;

FIG. 5 is a diagram exemplifying a configuration of a print job in the case where the print job is created by designating pages from a plurality of image files;

FIG. 6 is a diagram illustrating an exemplary display (exemplary setting) of a file name display area and a page range display area in the case of configuring the print job illustrated in FIG. 5; and

FIG. 7 is a flowchart illustrating an exemplary processing of an information processing program executed by an information processing apparatus to create a print job.

### DETAILED DESCRIPTION OF THE PREFERRED EMBODIMENTS

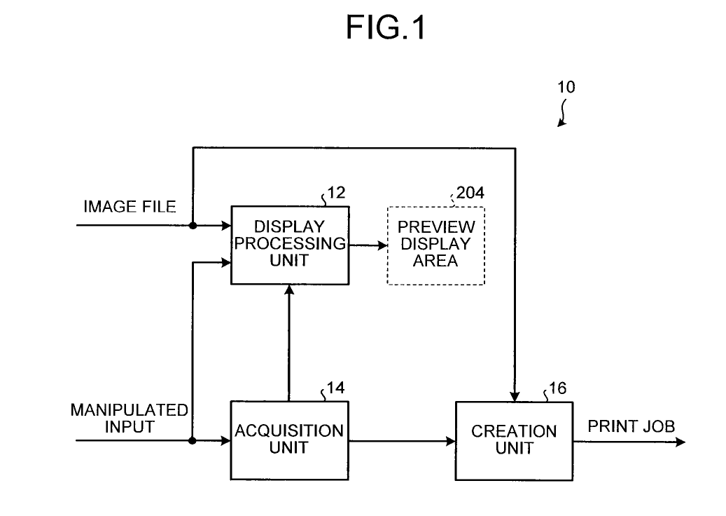

An information processing apparatus 10 according to an embodiment of the present invention will be described below with reference to the attached drawings. FIG. 1 is a functional block diagram illustrating an overview of a function that an information processing apparatus 10 according to an embodiment has. Note that the information processing apparatus 10 is a personal computer (PC) including, for example, a CPU, a storage device, and an input/output device, which are not illustrated. As illustrated in FIG. 1, the information processing apparatus 10 includes a display processing unit 12, an acquisition unit 14, and a creation unit 16.

The display processing unit 12 receives an image file and manipulated input by a user, and displays, on an output device (display device or the like), a preview display area 204, etc. which will be described later. In accordance with the manipulated input by the user, the acquisition unit 14 acquires designation information which will be described later, and outputs the acquired designation information to the display processing unit 12 and the creation unit 16. The creation unit 16 receives the image file and the designation information output from the acquisition unit 14, and creates a print job, using the image file corresponding to the designation information.

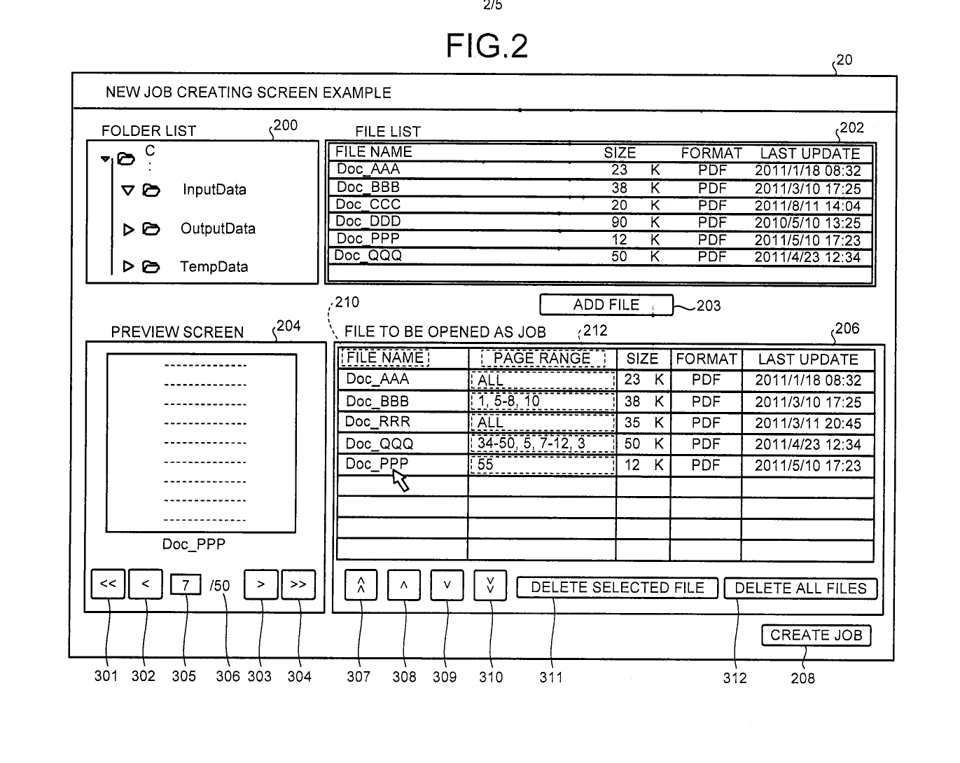

FIG. 2 is an exemplary view of a new job creating screen 20 displayed on the display device by the display processing unit 12 in accordance with the manipulated input by the user. As illustrated in FIG. 2, the new job creating screen 20 displayed by the display processing unit 12 includes a folder display area 200, a file display area 202, an addition input button 203, a preview display area 204, a job configuration display area 206, and a job creation button 208.

The folder display area 200 displays a list of folders contained in the information processing apparatus 10. The file display area 202 displays a list of files in a folder selected in the folder display area 200.

When the addition input button 203 is pushed (e.g., clicked) in the state where a file in the file display area 202 is selected, the selected file is displayed on a file name display area 210 of the job configuration display area 206. Here, the file displayed on the file name display area 210 is the file (image file) containing an original included in the print job.

The preview display area 204 displays a preview of content of the file selected in the file name display area 210 of the job configuration display area 206. The preview display area 204 includes buttons 301 to 304. Further, the preview display area 204 includes a page display area 305 and a display area of total number of pages 306.

For instance, the preview display area 204 displays a preview of a page displayed on the page display area 305 in the image file selected in the file name display area 210. Also, the page display area 305 functions as an input edit box where a value (page number) can be directly input. Therefore, when a user designates a page by inputting the page number in the page display area 305, the preview display area 204 displays a preview of the content of the page number input in the page display area 305. The display area of total number of pages 306 displays a total number of pages of the image file selected in the file name display area 210.

Further, when the button 301 is pushed, the preview display area 204 displays the first page of the image file selected in the file name display area 210. When the button 302 is pushed, the preview display area 204 displays a preceding page of a page currently displayed. When the button 303 is pushed, the preview display area 204 displays a subsequent page of the page currently displayed. When the button 304 is pushed, the preview display area 204 displays the last page of the image file selected in the file name display area 210.

Thus, the acquisition unit 14 (FIG. 1) acquires designation information that designates, in units of a page, a page in the image file when the page in the image file is designated by any of the buttons 301 to 304 and the page display area 305. Further, the display processing unit 12 (FIG. 1) receives, from the acquisition unit 14, the designation information that designates the page, and displays a preview of an image corresponding to the designation information on the preview display area 204.

The job configuration display area 206 includes the above-described file name display area 210, a page range display area 212 and so on, and displays pages in each of image files which form a job, for example, in the order of printing from the top. The page range display area 212 displays a range of pages to be printed included in the job for each of image files displayed on the file name display area 210. Also, the page range display area 212 functions as an input edit box in which respective pages in the image files to be designated can be input.

For example, in the case where the print target of the job is all of the pages in an image file which is an original file, the user inputs “all” in the page range display area 212 correspondingly to the image file name displayed on the file name display area 210. In this manner, the information processing apparatus 10 sets, as the print target, all of the pages in the image file for which “all” has been input.

Also, in the case where a specific page in the image file is designated as a print target of the job, the user directly inputs the page number in the page range display area 212. For instance, in the case where page 55 is designated as the print target, the user inputs “55” in the page range display area 212 correspondingly to the image file name displayed on the file name display area 210.

Further, in the case where pages of a continuous range in the image file are designated as the print target of the job, the user directly inputs the page numbers, i.e., start page number—end page number, on the page range display area 212. For example, in the case where continuous pages from 34 to 50 are designated as the print target, the user inputs “34-50” in the page range display area 212 correspondingly to the image file displayed on the file name display area 210.

The pages can be designated by arbitrary combination. For instance, in FIG. 2, page numbers “34-50, 5, 7-12, 3” are designated for the image file Doc_QQQ. In the case where the page numbers are thus designated, print will be performed in the order of pages 34 to 50, page 5, pages 7 to 12, and page 3 in the job.

Additionally, the job configuration display area 206 includes buttons 307 to 310, a first delete button 311, and a second delete button 312.

When the button 307 is pushed, the job configuration display area 206 displays an image file selected in the file name display area 210 on the top of the file name display area 210. In other words, when the button 307 is pushed, the image file selected in the file name display area 210 moves to the top of the job.

When the button 308 is pushed, the job configuration display area 206 displays the image file selected in the file name display area 210, moved up by one line in the file name display area 210. When the button 309 is pushed, the job configuration display area 206 displays the image file selected in the file name display area 210, moved down by one line in the file name display area 210. When the button 310 is pushed, the job configuration display area 206 displays the image file selected in the file name display area 210 at the lowest position of the file name display area 210. As described above, the order of the image files displayed in the job configuration display area 206 indicates the print order of the job.

When the first delete button 311 is pushed, the job configuration display area 206 deletes the image file that user selected in the file name display area 210. When the second delete button 312 is pushed, the job configuration display area 206 deletes all of the image files displayed in the file name display area 210.

That is to say, the information processing apparatus 10 is capable of adding and deleting image files, and changing the order of the image files via the job configuration display area 206, and specifies the job in which the print target pages included in the image files are listed from the top of the job configuration display area 206.

When the job creation button 208 is pushed, the creation unit 16 (FIG. 1) creates a print job such that the job specified via the job configuration display area 206 forms, for example, a set of files (document creation). The print job corresponds to submission of an original to the printing and editing system or the like, which creates the print document data from the image data. Therefore, the user can confirm the content of the original file by displaying a preview of the content, and simultaneously can designate the page range before submitting the original to the printing and editing system.

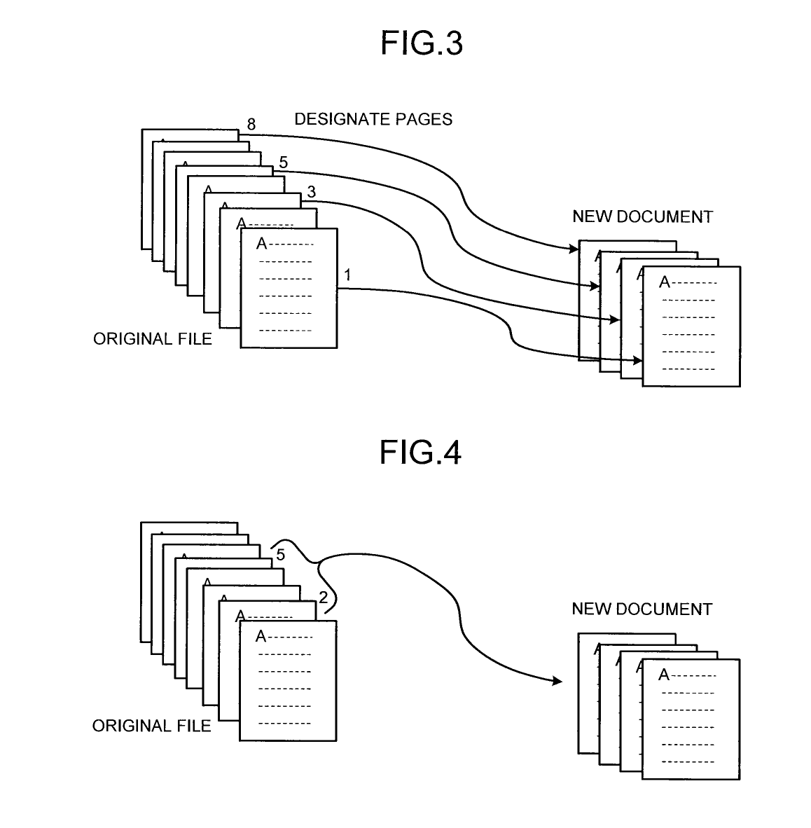

Next, operation of the information processing apparatus 10 will be described, providing specific examples. FIG. 3 is a diagram exemplifying a relation between an image file (original file) and a print job (new document to be submitted) in the case where specific pages are designated on the new job creating screen 20. For example, in the case where only pages 1, 3, 5, and 8 out of pages 1 to 8 in the image file (original file) are to be submitted as the new document, the print job is set by inputting values 1, 3, 5, 8 in the page range display area 212 illustrated in FIG. 2.

FIG. 4 is a diagram exemplifying a relation between an image file (original file) and a print job (new document to be submitted) in the case where continuous pages are designated on the new job creating screen 20. For example, in the case where pages 2 to 5 out of pages 1 to 8 in the image file (original file) are to be submitted as the new document, the print job is set by inputting 2-5 in the page range display area 212 illustrated in FIG. 2.

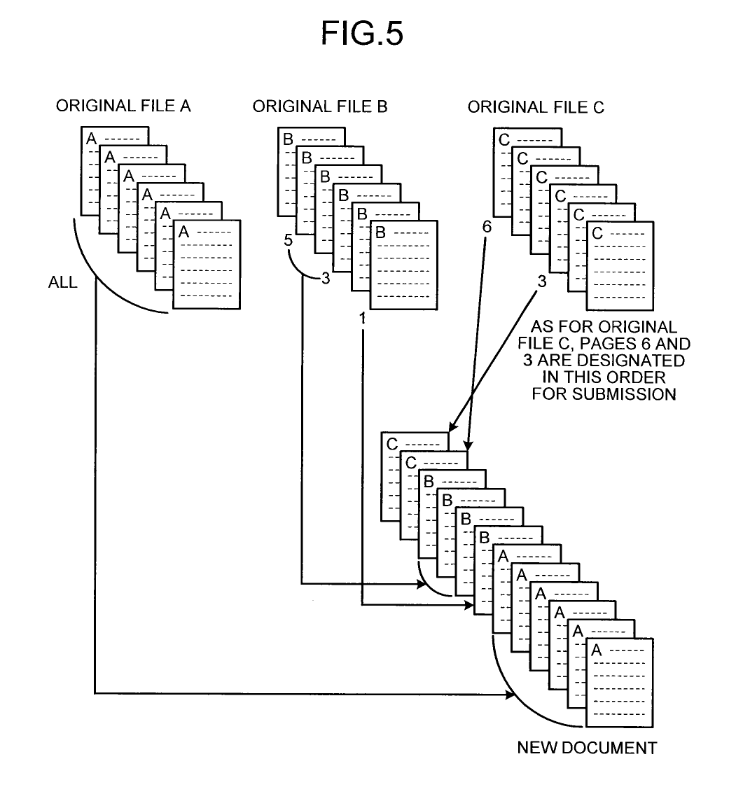

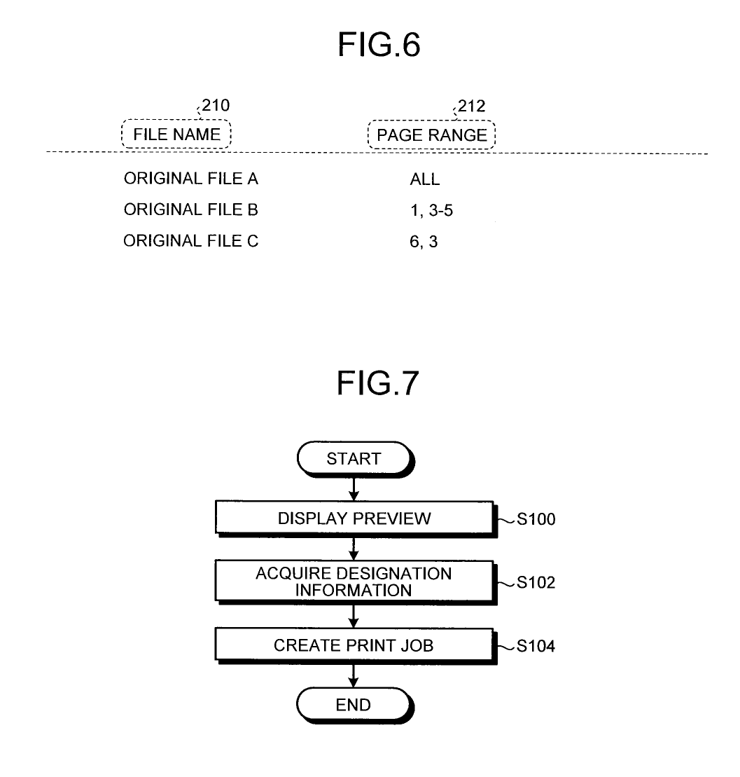

FIG. 5 is a diagram exemplifying a configuration of the print job (new document to be submitted) in the case where the print job is created by designating pages from a plurality of image files (original files). FIG. 6 is a diagram illustrating an exemplary display (exemplary setting) of the file name display area 210 and the page range display area 212 in the case of configuring the print job illustrated in FIG. 5. For instance, in the case of creating a new document by unifying a plurality of original files including all pages of an original file A, pages 1 and 3 to 5 of an original file B, and pages 6 and 3 of an original file C in this order (FIG. 5), the original files are set in the order of A, B and C in the file name display area 210, and the page numbers are set in the order of “all”, “1, 3-5”, and “6, 3” from the top line of the page range display area 212.

Next, an information processing program executed for the information processing apparatus 10 to create a print job will be described. FIG. 7 is a flowchart illustrating an exemplary processing of an information processing program executed in order that the information processing apparatus 10 creates a print job.

As illustrated in FIG. 7, in step 100 (S100), the display processing unit 12 displays, on a display device or the like not illustrated, the new job creating screen 20 including the preview display area 204 which displays a preview of content of an image file in accordance with manipulated input by a user.

In step 102 (S102), the acquisition unit 14 acquires designation information that designates, in units of a page, an image to be printed contained in the image file in accordance with the manipulated input by the user.

In step 104 (S104), the creation unit 16 receives the image file and the designation information acquired by the acquisition unit 14, and creates a print job, using the image file corresponding to the designation information.

Incidentally, the information processing program executed in the information processing apparatus 10 according to the present embodiment has a module structure that includes the above-mentioned units (such as the display processing unit 12, the acquisition unit 14, and the creation unit 16). Additionally, as actual hardware, the CPU not illustrated reads the information processing program from a storage medium and executes the program, thereby loading each of the above-mentioned units on a main storage device.

The information processing program executed in the information processing apparatus 10 according to the present embodiment are recorded in a computer-readable recording medium such as a CD-ROM, a flexible disc (FD), a CD-R, a DVD (Digital Versatile Disc) as a file in an installable format or an executable format, and is provided as a computer program product.

It is also possible to configure the information processing program executed in the information processing apparatus 10 according to the present embodiment to be store on a computer connected to a network such as the Internet so as to provide the program by downloading via the network.

Also, the information processing program according to the present embodiment may be incorporated in advance in the ROM and the like to provide the program.

According to an embodiment, provided is an effect in that an unnecessary page can be effectively excluded beforehand in the case of unifying the image files in one document.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a display processing unit configured to display a preview of content of an image file;
an acquisition unit configured to acquire designation information which designates an image to be printed in the image file in units of a page; and
a creation unit configured to create a print job in which a page designated by the designation information is to be printed.

2. The information processing apparatus according to claim 1, wherein the display processing unit displays a preview of an image corresponding to the designation information.

3. An information processing method comprising:
displaying a preview of content of an image file;
acquiring designation information which designates, in units of a page, an image to be printed in the image file; and
creating a print job in which a page designated by the designation information is to be printed.

4. A computer program product comprising a non-transitory computer-usable medium having computer-readable program codes embodied in the medium, wherein the program codes when executed cause a computer to execute:
displaying a preview of content of an image file;
acquiring designation information which designates, in units of a page, an image to be printed in the image file; and
creating a print job in which a page designated by the designation information is to be printed.
